(19) United States
(12) Patent Application Publication
(10) Pub. No.: US 2017/0052841 A1
(43) Pub. Date: Feb. 23, 2017

(54) MANAGEMENT APPARATUS, COMPUTER AND NON-TRANSITORY COMPUTER-READABLE RECORDING MEDIUM HAVING MANAGEMENT PROGRAM RECORDED THEREIN

(71) Applicant: FUJITSU LIMITED, Kawasaki-shi (JP)

(72) Inventor: Hajime Ogino, Kawasaki (JP)

(73) Assignee: FUJITSU LIMITED, Kawasaki-shi (JP)

(21) Appl. No.: 15/236,504

(22) Filed: Aug. 15, 2016

(30) Foreign Application Priority Data
Aug. 20, 2015 (JP) 2015-162469

(51) Int. Cl. G06F 11/07; G06F 11/34; G06F 11/30

(52) U.S. Cl. CPC G06F 11/0793; G06F 11/0706; G06F 11/0751; G06F 11/079; G06F 11/3003; G06F 11/3055; G06F 11/3058; G06F 11/3495

(57) ABSTRACT

Erroneous detection of a communication failure accompanying an OS shutdown is prevented by including a communication failure detector configured to detect a communication failure concerning a data communication path, a software monitor configured to detect an abnormally stopped state of management software when the communication failure is detected, and a failure manager configured to confirm a power state of a computer, after waiting for a time period taken to shut down the computer from the detection of the communication failure in a case where the abnormally stopped state of the management software is detected, and cancel, when the computer is confirmed to be in a power-off state, the communication failure detected.

### CROSS-REFERENCE TO RELATED APPLICATION

This application is based upon and claims the benefit of priority of the prior Japanese Patent application No. 2015-162469, filed on Aug. 20, 2015, the entire contents of which are incorporated herein by reference.

### FIELD

The embodiment discussed herein is directed to a management apparatus, a computer, and a non-transitory computer-readable recording medium having a management program recorded therein.

### BACKGROUND

Some of computers such as IA (Intel (registered trademark) Architecture) servers use a Peripheral Component Interconnect Express (PCIe) bus as an I/O (Input/Output) bus.

In a computer including such a PCIe bus, CPU (Central Processing Unit) is connected to a plurality of PCIe interfaces (PCIe cards) via a PCIe switch. The PCIe switch and each of the PCIe cards are connected by a PCIe bus respectively.

The PCIe bus has an error detection function and errors and performance degradation as described below are detected:

(1) Uncorrectable Internal Error (internal error that is uncorrectable)

(2) Receiver Overflow (overflow is detected by a receiver)

(3) Flow Control Protocol Error (error in flow control protocol)

(4) Receiver Error (error in a receiver)

(5) Corrected Internal Error (internal error that is corrected)

(6) Speed degraded (degraded transfer speed)

(7) Lane degraded (degraded lane width)

Among these, errors in (1) to (5) described above are caused by a hardware failure and when any one of these errors is detected, the server needs to be stopped swiftly. Thus, when any one of these errors is detected, a notification is made to the CPU by an interrupt.

The CPU having received the interrupt starts logic of error handling. The user is notified of an occurrence of error by an error log being registered by BMC (Baseboard Management Controller) in a System Event Log (SEL).

Thus, when any one of errors in (1) to (5) described above occurs, an interrupt is caused and the user can be notified of the error by using the interrupt as a trigger. Regarding performance degradation in (6) and (7) described above, by contrast, the server computer can run without going down even if an error occurs. Thus, the BMC performs monitoring periodically. Therefore, the BMC needs to check whether an error has occurred.

FIG. 16 is a diagram illustrating standards of a transfer speed and a lane width of PCIe.

As illustrated in FIG. 16, three standards (PCIe versions) are available in PCIe and the transfer speeds are different depending on the PCIe versions. In addition, in each PCIe version, communication in a plurality of lane widths can be performed.

In PCIe, when an error occurs in communication of a high transfer speed standard, the operation can be continued by reconnecting at a lower transfer speed. For example, in communication using a PCIe switch supporting 8.0 Gbps and a PCI card, if an error is detected in the communication at 8.0 Gbps, the operation may be continued by switching to communication at 5.0 Gbps or 2.5 Gbps. On the other hand, however, the transfer speed is degraded and thus, performance degradation may arise, affecting the operation.

Each PCIe port connected to the PCI card in the PCIe switch includes a Link Capability register and a Link Status register.

The Link Capability register has the originally set transfer speed (ideal value) and lane width stored therein. The Link Status register has the actually operating transfer speed and lane width stored therein.

The BMC reads values from these two registers for each PCIe port via a I2C bus interface and, if the values are different, determines that the transfer speed and lane width are degraded in the PCIe bus.

However, while the OS (Operating System) is shut down, devices are closed in stages and thus, the transfer speed may be degraded. Because a speed degraded value is reflected in the Link Status register of the PCIe port described above, the BMC may erroneously recognize an error even if the OS is being shut down. Thus, the transfer speed needs to be monitored only while the OS is running and the BMC needs to determine whether the OS is running.

Hereinafter, the OS shutdown may simply be called a shutdown.

As an industry standard for implementing a notification to the BMC that the OS is running, a communication interface called IPMI (Intelligent Platform Management Interface) between BMC and OS is known. In IPMI, an OS Running notification notifying that the OS is activated and an OS Shutdown notification notifying that the OS is shut down are defined as command interface specifications for notification from OS to BMC.

In the case of an IA server, however, the vendor of hardware and that of the OS are different like the server body is developed by a server vendor while the OS running on the server is developed by an OS vendor. Whether or not to implement a process to notify the user of a shutdown when the OS is shut down depends on the vendor. Also, even if an OS vendor implements a process to notify the user of a shutdown, the user using the server may disable the notification process so that no shutdown notification is made.

In the IA server, therefore, server vendor specific software (server management software) is operated to allow the server management software to notify the BMC of an OS operating state so that the BMC is reliably notified of an OS shutdown. The BMC stores the OS Running notification and the OS Shutdown notification notified from the server management software operating on the OS in an internal OS state storage unit and determines that the OS is in an operating state by referring to the value thereof.

FIG. 17 is a sequence diagram illustrating a PCIe bus monitoring process on a conventional IA server.

The BMC periodically performs the PCIe bus monitoring process to acquire a power state pf the server (see Symbol A0). If the server is in a power-off state, the BMC does not monitor the PCIe bus. The server is activated by a power-on instruction from the user (see Symbol A1). The server boots the OS (see Symbol A2) and server management software is activated by the OS (see Symbol A3).

The server management software transmits an OS Running notification to the BMC (see Symbol A4). The BMC having received the OS Running notification stores information indicating that the OS is running in the OS state storage unit. In the case of OS Running, the BMC monitors the PCIe bus (see Symbol A5). The monitoring of the PCIe bus is performed periodically (see Symbol A6).

The BMC reads each value of the Link Capability register and the Link Status register in the PCIe port and checks whether the degradation of transfer speed occurs by comparing these values. In the example illustrated in FIG. 17, “0x00000003” is stored in each of the Link Capability register and the Link Status register as the PCIe register value, representing a normal state.

Then, when the user inputs an OS shutdown instruction (see Symbol A7), the OS stops the server management software (see Symbol A8). The server management software transmits an OS Shutdown notification to the BMC (see Symbol A9). The BMC having received the OS Shutdown notification stores information indicating that the OS is to be shut down in the OS state storage unit. In the case of OS Shutdown, the BMC does not perform monitoring of the PCIe bus (see Symbol A10).

FIG. 18 is a sequence diagram illustrating an error detection process on the conventional IA server.

In FIG. 18, the same symbols as those described above indicate similar processes and a description thereof is omitted.

Also in FIG. 18, the illustration of a portion of processes illustrated in FIG. 17 is omitted.

When the server management software transmits an OS Running notification to the BMC (see Symbol A4), the BMC having received the OS Running notification stores information indicating that the OS is running in the OS state storage unit. In the case of OS Running, the BMC monitors the PCIe bus (see Symbol A5).

The BMC reads each value of the Link Capability register and the Link Status register in the PCIe port and checks whether the degradation of transfer speed occurs by comparing these values. If the PCIe bus is normal, the value of the Link Capability register and that of the Link Status register match (for example, “0x00000003”).

When the PCIe transfer speed is degraded in the PCIe bus (see Symbol B1), then when the PCIe bus is monitored by the BMC (see Symbol B2), the value of the Link Capability register and that of the Link Status register in the PCIe port differ. In the example illustrated in FIG. 18, while the PCIe register value “0x00000003” is stored in the Link Capability register, the PCIe register value “0x00000001” is stored in the Link Status register due to the degradation of transfer speed arising in the PCIe bus.

Based on the difference between the value of the Link Capability register and that of the Link Status register in the PCIe port (“Link Status register”≠“Link Capability register”), the BMC determines that the degradation of transfer speed has occurred.

The BMC registers an error log (error message) in SEL (see Symbol B3).

When an error message is registered in SEL, the support center or the like is notified of an occurrence of error and maintenance work is done by maintenance workers.

Patent Document 1: Japanese Laid-open Patent Publication No. 2006-172218

Patent Document 2: Japanese Laid-open Patent Publication No. 2007-265157

However, if the OS is shut down in such a conventional IA server while the server management software hangs up, no OS Shutdown notification is transmitted from the server management software.

FIG. 19 is a sequence diagram illustrating a process when an OS shutdown is carried out while the server management software hangs up on the conventional IA server.

In FIG. 19, the same symbols as those described above indicate similar processes and a description thereof is omitted. Also in FIG. 19, the illustration of a portion of processes illustrated in FIG. 17 is omitted.

When the server management software transmits an OS Running notification to BMC (see Symbol A4), the BMC having received the OS Running notification stores information indicating that the OS is running in the OS state storage unit. In the case of OS Running, the BMC monitors the PCIe bus (see Symbol A5).

Here, if the server management software hangs up (see Symbol C1) and then the user carries out an OS shutdown (see Symbol C2), the OS Shutdown notification to be transmitted is not transmitted to the BMC (see Symbol C3) because the server management software is hung.

The BMC does not receive any OS Shutdown notification and continues with monitoring of the PCIe bus (see Symbol C4).

Devices are closed in stages during OS shutdown as described above and thus, the transfer speed of the PCIe bus may be degraded and the PCIe register value “0x00000001” indicating a degraded transfer speed is thereby stored in the Link Status register of the PCIe port.

The BMC checks, as monitoring of the PCIe bus, whether the transfer speed is degraded by reading each value of the Link Capability register and the Link Status register in the PCIe port and comparing these values.

In the example illustrated in FIG. 19, while the PCIe register value “0x00000003” is stored in the Link Capability register, the PCIe register value “0x00000001” is stored in the Link Status register due to the degradation of transfer speed arising in the PCIe bus.

Based on the difference between the value of the Link Capability register and that of the Link Status register in the PCIe port (“Link Status register” 0 “Link Capability register”), the BMC determines that the degradation of transfer speed has occurred.

The BMC registers an error log (error message) in SEL (see Symbol C5).

Thus, if the OS is shut down while the server management software hangs up in a conventional IA server, no OS Shutdown notification is transmitted from the server management software.

Accordingly, the BMC continues to monitor the PCIe bus while the OS is shut down and detects the degraded transfer speed of the PCIe bus due to closure (close down) of devices in stages carried out during OS shutdown, leading to erroneous detection of an error.

Accordingly, though actually the OS is simply shut down, an error is detected and a problem of unnecessary maintenance work or the like being created is posed.

### SUMMARY

According to an aspect of the embodiments, a management apparatus includes a communication failure detector configured to detect a communication failure concerning a data communication path by monitoring a communication state of the data communication path included in the computer, a software monitor configured to detect an abnormally stopped state of management software executed by the computer and which outputs state information of the computer when the communication failure is detected by the communication failure detector, and a failure manager configured to confirm a power state of the computer, after waiting for a time period taken to shut down the computer from the detection of the communication failure by the communication failure detector in a case where the abnormally stopped state of the management software is detected, and cancel, when the computer is confirmed to be in a power-off state, the communication failure detected by the communication failure detector.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram schematically illustrating a hardware configuration and a software configuration of an IA server as an exemplary embodiment;

FIG. 2 is a diagram illustrating software configuration information for the IA server as an exemplary embodiment;

FIG. 3 is a block diagram illustrating an exemplary hardware configuration of BMC provided on the IA server as an exemplary embodiment;

FIG. 4 is a diagram illustrating hardware configuration information for the IA server as an exemplary embodiment;

FIG. 5 is a sequence diagram illustrating a hang-up detection process of server management software by a server management software monitor of the IA server as an exemplary embodiment;

FIG. 6 is a sequence diagram illustrating a collection process of various kinds of information for the IA server as an exemplary embodiment;

FIG. 7 is a flow chart illustrating a process by a PCIe bus monitoring processor for the IA server as an exemplary embodiment;

FIG. 8 is a flow chart illustrating a measuring process of an OS shutdown time by a shutdown time measuring unit of the IA server as an exemplary embodiment;

FIG. 9 is a flow chart illustrating a comparison process of the software configuration by a configuration information comparator of the IA server as an exemplary embodiment;

FIG. 10 is a flow chart providing an overview of the comparison process of the hardware configuration by the configuration information comparator of the IA server as an exemplary embodiment;

FIG. 11 is a flow chart illustrating a configuration comparison process of CPU by the configuration information comparator of the IA server as an exemplary embodiment;

FIG. 12 is a flow chart illustrating the configuration comparison process of DIMM by the configuration information comparator of the IA server as an exemplary embodiment;

FIG. 13 is a flow chart illustrating the configuration comparison process of HDD by the configuration information comparator of the IA server as an exemplary embodiment;

FIG. 14 is a flow chart illustrating the configuration comparison process of a PCIe card by the configuration information comparator of the IA server as an exemplary embodiment;

FIG. 15 is a sequence diagram illustrating a process when a degraded speed is detected in a PCIe bus during OS shutdown in the IA server as an exemplary embodiment;

FIG. 16 is a diagram illustrating standards of a transfer speed and a lane width of PCIe;

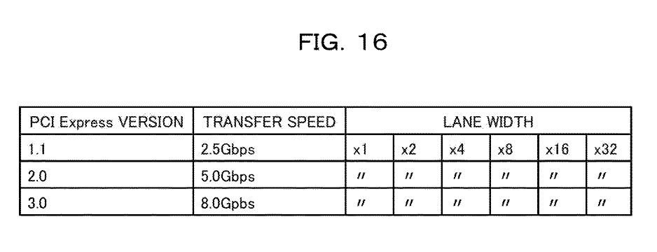

FIG. 17 is a sequence diagram illustrating a PCIe bus monitoring process on a conventional IA server;

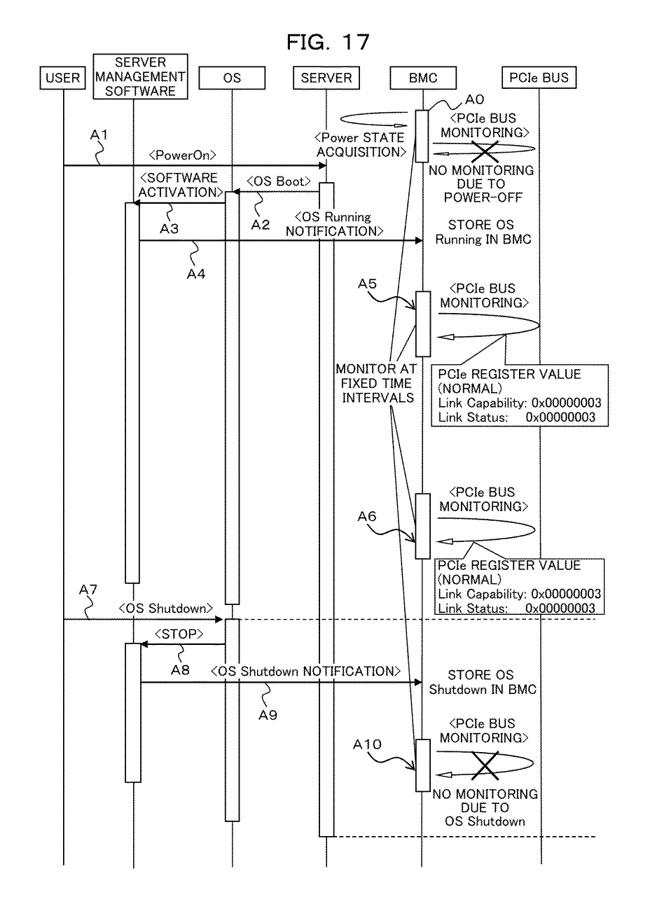

FIG. 18 is a sequence diagram illustrating an error detection process on the conventional IA server; and

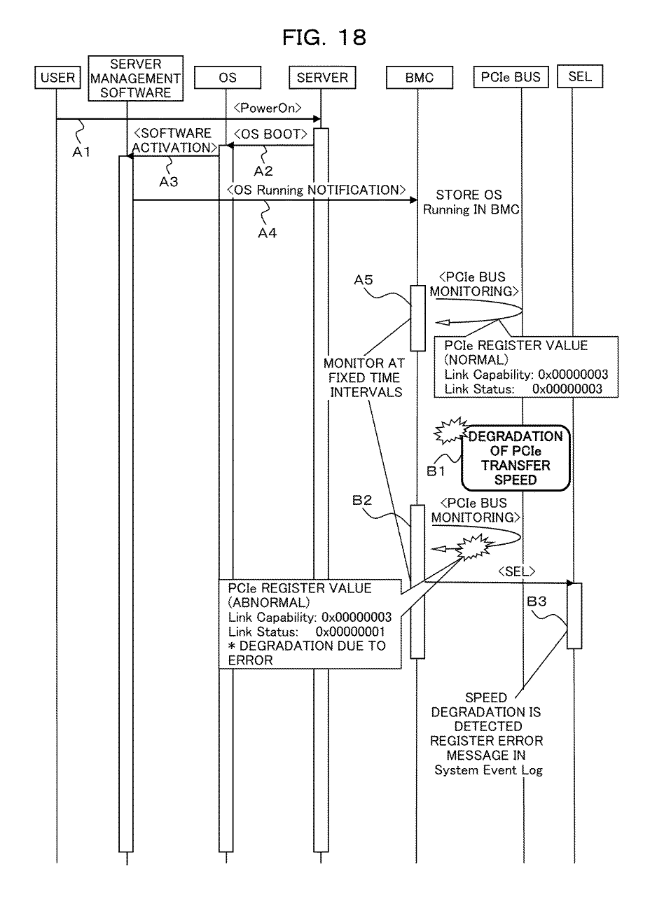

FIG. 19 is a sequence diagram illustrating a process when an OS shutdown is carried out while the server management software hangs up on the conventional IA server.

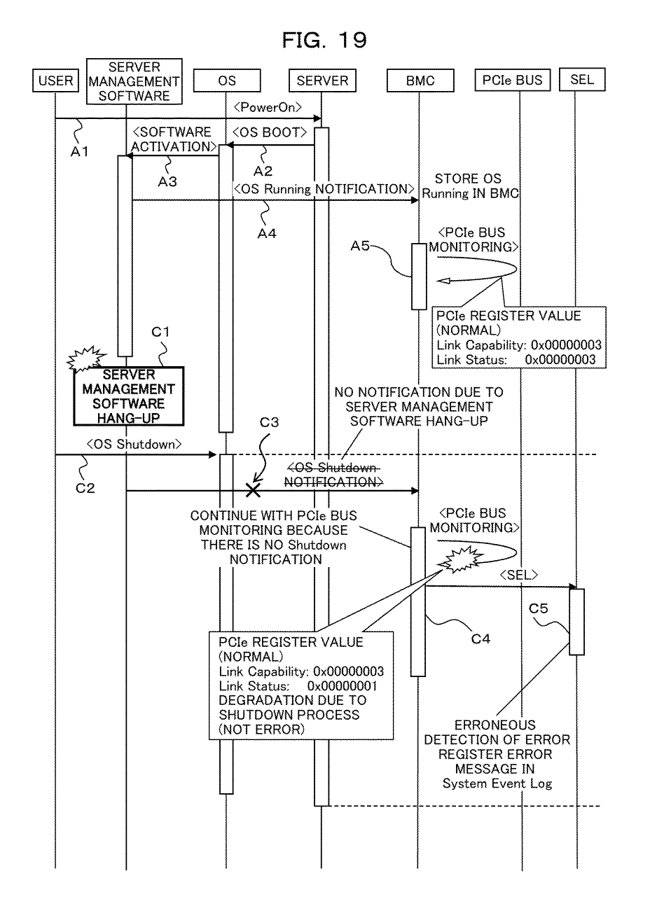

### DESCRIPTION OF EMBODIMENT

Hereinafter, an embodiment related to the present management apparatus, a computer, and a management program will be described with reference to the drawings. However, the embodiment described below is only by way of illustration and does not intend to exclude application of various modifications and technologies not explicitly described in the embodiment. That is, the present embodiment can be carried out by making various modifications without deviating from the spirit thereof. Each diagram is not intended to include only components illustrated in the diagram and may include other functions.

(A) Configuration

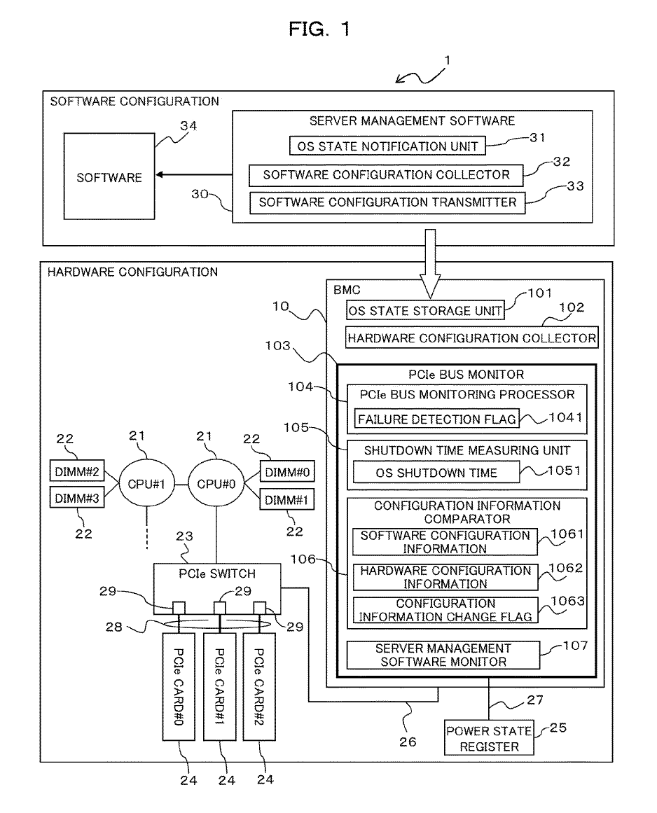

FIG. 1 is a diagram schematically illustrating a hardware configuration and a software configuration of a computer as an exemplary embodiment.

A computer 1 illustrated in FIG. 1 is, for example, an IA server. Hereinafter, the computer 1 may be called an IA server 1.

The IA server 1 includes, as a software configuration, server management software 30 and software 34. The server management software 30 and the software 34 are executed by a CPU 21 described below.

The software 34 is a software program installed on the IA server 1 and executed and is, for example, Redhat (registered trademark)-release-server, Network Manager, opensssh-clients, gzip, firwalld, or pkgconfig. The software 34 also includes an OS and Network Manager, opensssh-clients, gzip, firwalld, and pkgconfig are each executed on Redhat-release-server as an OS.

The server management software 30 manages a software environment of the IA server 1.

The server management software 30 includes, as illustrated in FIG. 1, functions as an OS state notification unit 31, a software configuration collector 32, and a software configuration transmitter 33.

The OS state notification unit 31 notifies a BMC 10 of the state of OS. If, for example, the OS is being executed, the OS state notification unit 31 transmits an OS Running notification as a notification indicating “OS Running” to the BMC 10. If the OS is shut down, the OS state notification unit 31 transmits an OS Shutdown notification as a notification indicating “OS Shutdown” to the BMC 10. Hereinafter, the OS Running notification and the OS Shutdown notification may be called OS state notification information.

Thus, the server management software 30 functions as management software executed by the CPU 21 to output OS state notification information as state information of the IA server system 1.

The software configuration collector 32 collects information about the software 34 installed on the present IA server 1.

The software configuration collector 32 periodically issues an OS standard command to collect information about the software 34 installed on the present IA server 1.

The server management software 30 periodically (for example, every five seconds) transmits a reset request of Watchdog Timer to the BMC 10.

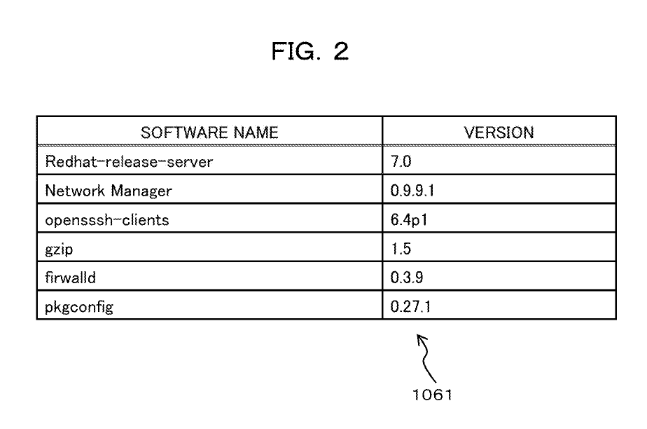

FIG. 2 is a diagram illustrating software configuration information 1061 for the IA server 1 as an exemplary embodiment.

The software configuration information 1061 illustrated in FIG. 2 is managed by associating the name (software name) of the software 34 (including the OS) installed on the IA server 1 and the version thereof.

The software configuration transmitter 33 notifies the BMC 10 of the software configuration information 1061 collected by the software configuration collector 32.

The software configuration transmitter 33 notifies the BMC 10 described below of software configuration information collected by the software configuration collector 32. The BMC 10 stores the received information in a memory 12 as the software configuration information 1061.

Because the software configuration may be changed even while the OS operates, the software configuration collector 32 desirably collects the software configuration information 1061 periodically so that the software configuration transmitter 33 transmits the software configuration information 1061 collected as described above to the BMC 10. Accordingly, the BMC 10 can hold the software configuration information 1061 that is the latest.

The IA server 1 includes, as a hardware configuration, the BMC 10, the CPU 21, a DIMM (Dual Inline Memory Module) 22, a PCIe switch 23, a PCIe card 24, and a Power state register 25.

The Power state register 25 is connected to the BMC 10 via an internal bus 27. The power state (power-on/power-off) of the IA server 1 is set to the Power state register 25. That is, a setting indicating a power-on state is stored in the Power state register 25 while the IA server 1 is turned on and a setting indicating a power-off state is stored in the Power state register 25 while the IA server 1 is turned off.

The CPU 21 is a processor performing various kinds of control and calculations and implements various functions by executing the OS and the software 34 stored in the DIMM 22 or the like.

In the example illustrated in FIG. 1, two units of the CPU 21 (CPU#0, #1) are provided.

One unit or more (two units in the example illustrated in FIG. 1) of the DIMM 22 are connected to each of the CPUs 21.

The DIMM 22 is a storage area to store various kinds of data and programs and data and programs are stored and expanded for use when the CPU 21 executes the OS or the software 34.

A plurality of the PCIe cards 24 is connected to each of the CPUs 21 via the PCIe switch 23. In the example illustrated in FIG. 1, the illustration of the PCIe switch 23 and the PCIe cards 24 connected to the CPU#1 is omitted for the sake of convenience.

The PCIe cards 24 are a PCIe interface and various devices conforming to PCIe standards are connected to each. The PCIe switch 23 performs control to appropriately switch the connection between the plurality of PCIe cards 24 and the CPU 21.

The PCIe switch 23 includes a plurality of ports 29 and the PCIe card 24 is connected to each of the ports 29. The PCIe port 29 includes a Link Capability register and a Link Status register.

The Link Capability register has the originally set transfer speed (ideal value) and lane width stored therein. The Link Status register has the actually operating transfer speed and lane width stored therein.

The PCIe switch 23 is connected to the BMC 10 via a I2C bus 26.

Also, one unit or more of HDD (Hard Disk Drive) (not illustrated) are connected to the IA server 1.

The BMC 10 is a management apparatus that monitors the state of hardware in the IA server 1. The BMC 10 has power supplied thereto independently of the CPU 21 and always monitors the state of hardware in the IA server 1. The BMC 10 has a PCIe bus monitoring function that performs monitoring of the PCIe bus 28 on the IA server 1.

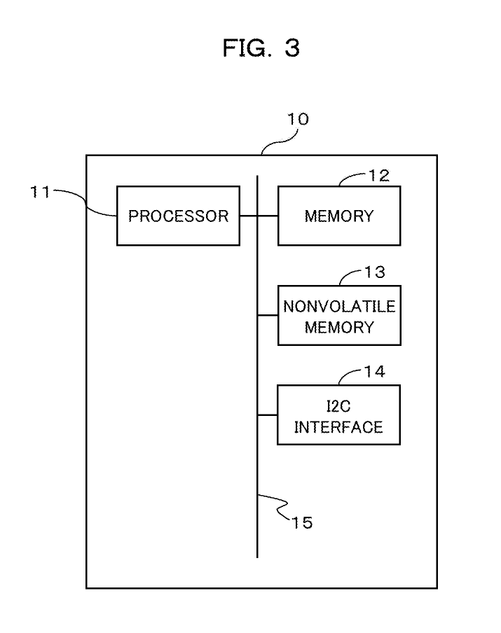

First, the hardware configuration of the BMC (management apparatus, information processing apparatus) 10 implementing the PCIe bus monitoring function in the present embodiment will be described with reference to FIG. 3. FIG. 3 is a block diagram illustrating an exemplary hardware configuration of the BMC 10 provided on the IA server 1 as an exemplary embodiment.

The BMC 10 has, for example, a processor 11, the memory 12, a nonvolatile memory 13, and an I2C interface 14 as components thereof. These components 11 to 14 are communicably connected to each other via a bus 15.

The processor 11 controls the BMC 10 as a whole. The processor 11 may be a multiprocessor. The processor 11 may be one of CPU, MPU (Micro Processing Unit), DSP (Digital Signal Processor), ASIC (Application Specific Integrated Circuit), PLD (Programmable Logic Device), and FPGA (Field Programmable Gate Array). Alternatively, the processor 11 may be a combination of at least two elements selected from CPU, MPU, DSP, ASIC, PLD, and FPGA.

The memory 12 is used as the main storage device of the BMC 10. At least a portion of the OS program and application programs the processor 11 is caused to execute is temporarily stored in the memory 12. Also, various kinds of data needed for processes by the processor 11 are stored in the memory 12. Application programs may include a management program executed by the processor 11 to implement the PCIe monitoring function in the present embodiment by the BMC 10.

In the memory 12, a failure detection flag 1041, an OS shutdown time 1051, the software configuration information 1061, hardware configuration information 1062, and a configuration information change flag 1063 (see FIG. 1 described below) described below are each stored in predetermined storage areas. Also, the OS shutdown time measured by a shutdown time measuring unit 105 described below is temporarily stored in a predetermined area (measured time temporary storage area) of the memory 12.

Further, for the software configuration information 1061 and the hardware configuration information 1062, the software configuration information 1061 and the hardware configuration information 1062 that are the latest (latest generation) and the software configuration information 1061 and the hardware configuration information 1062 when the last OS shutdown occurred (previous generation) are stored in the memory 12 for the two generations.

The nonvolatile memory 13 writes and reads data. The nonvolatile memory 13 is used as an auxiliary storage device of the BMC 10. The OS program, application programs, and various kinds of data are stored in the nonvolatile memory 13. Incidentally, a semiconductor storage device (SSD: Solid State Drive) such as a flash memory may also be used as the auxiliary storage device.

The I2C interface 14 is a communication interface to connect a peripheral device conforming to the I2C standard to the BMC 10. For example, the PCIe switch 23 described above is connected to the I2C interface 14 via the I2C bus 26.

The BMC 10 reads the values of the Link Capability register and the Link Status register of each of the PCIe ports 29 of the PCIe switch 23 via the I2C interface 14.

The PCIe bus monitoring function in the present embodiment described below can be implemented by the BMC 10 having the hardware configuration described above.

Incidentally, the BMC 10 implements the PCIe bus monitoring function in the present embodiment by executing a program (management program or the like) recorded in, for example, a non-transitory computer-readable recording medium. A program describing processing content the BMC 10 is caused to perform can be recorded in various recording media. For example, a program the computer 10 is caused to execute can be stored in the nonvolatile memory 13. The processor 11 loads at least a portion of the program in the nonvolatile memory 13 into the memory 12 and executes the loaded program.

A program the BMC 10 (processor 11) is caused to perform can also be recorded in a non-transitory portable recording medium such as an optical disk, a memory device, a memory card or the like. A program stored in a portable recording medium becomes executable after being installed in HDD (not illustrated) under the control of, for example, the processor 11. Also, the processor 11 can read out a program directly from a portable recording medium and execute the program.

Next, the functional configuration of the BMC (computer) 10 having the PCIe bus monitoring function in the present embodiment will be described with reference to FIG. 1.

The BMC 10 has, as illustrated in FIG. 1, functions of at least an OS state storage unit 101, a hardware configuration collector 102, a PCIe bus monitoring processor 104, the shutdown time measuring unit 105, a configuration information comparator 106, and a server management software monitor 107.

Then, among these, particularly the PCIe bus monitoring processor 104, the shutdown time measuring unit 105, the configuration information comparator 106, and the server management software monitor 107 function as a PCIe bus monitor 103.

The OS state storage unit 101 is, for example, the memory 12 as illustrated FIG. 3 and stores OS state notification information notified from the OS state notification unit 31 of the server management software 30.

That is, a value indicating “OS Running” is stored in the OS state storage unit 101 when the OS is being executed and a value indicating “OS Shutdown” is stored when the OS is shut down. Therefore, a value indicating an execution state of the OS is stored in the OS state storage unit 101.

The hardware configuration collector 102 is, for example, the processor 11 as illustrated FIG. 3 and collects the hardware configuration information 1062 of the IA server 1. The hardware configuration collector 102 collects the hardware configuration information 1062 by directly accessing each piece of hardware provided in the IA server 1 via an internal bus.

The hardware configuration collector 102 stores collected information in a predetermined area of the memory 12 as the hardware configuration information 1062.

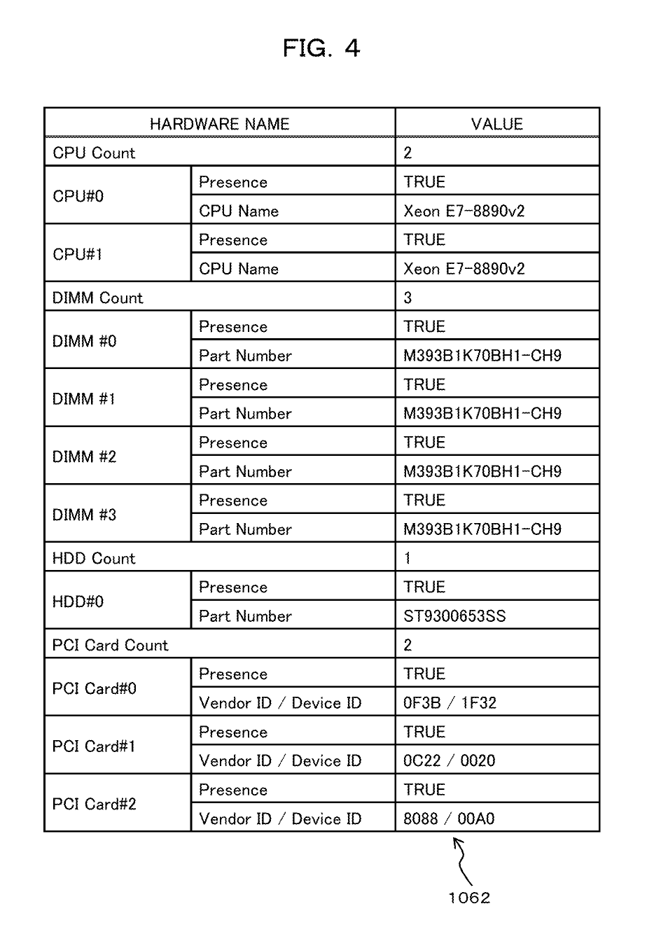

FIG. 4 is a diagram illustrating the hardware configuration information 1062 for the IA server 1 as an exemplary embodiment.

The hardware configuration information 1062 indicates the state of each piece of hardware mounted on the IA server 1. In the hardware configuration information 1062 illustrated in FIG. 4, each value of the management item is associated with the name (hardware name) to identify hardware.

Management information includes, for example, Count, Presence, CPU Name, Part Number, Vendor ID, and Device ID and information to be managed is appropriately different depending on hardware.

Count is the number of pieces of the relevant hardware and Presence indicates whether or not the relevant hardware is present. For example, “True” is set if the relevant hardware is mounted and “False” is set if the relevant hardware is not mounted. Part Number is a parts number of hardware and CPU Name is, for example, the product name of CPU. Vendor ID and Device ID are preset identification information to identify the vendor and the device respectively.

Because the hardware configuration may be changed even while the OS operates, the hardware configuration collector 102 desirably collects and updates the hardware configuration information 1062 periodically. Accordingly, the BMC 10 can hold the hardware configuration information 1062 that is the latest.

The shutdown time measuring unit 105 is, for example, the processor 11 as illustrated FIG. 3 and measures the OS shutdown time. When the configuration information comparator 106 described below detects a configuration change of the IA server 1, the shutdown time measuring unit 105 stores the time measured using a timer (not illustrated) as the OS shutdown time 1051.

When an OS Shutdown notification is received from the server management software 30, the shutdown time measuring unit 105 activates the timer to start clocking the time. When power-off of the IA server 1 is detected, the shutdown time measuring unit 105 stops the timer. The shutdown time measuring unit 105 temporarily stores the time (measured time) between the activation and the stop of the timer in a predetermined area (measured time temporary storage area) of the memory 12.

If, as a result of comparison by the configuration information comparator 106, the configuration of the IA server 1 is changed, the shutdown time measuring unit 105 updates the value of the OS shutdown time 1051 by overwriting using the value (time) temporarily stored in the measured time temporary storage area of the memory 12.

If the configuration of the IA server 1 is not changed and the OS shutdown time stored in the measured time temporary storage area and measured this time is longer than the OS shutdown time 1051, that is, the OS shutdown time measured previously, the shutdown time measuring unit 105 updates the value of the OS shutdown time 1051 by overwriting using the value stored in the measured time temporary storage area.

Incidentally, if the configuration of the IA server 1 is not changed and the OS shutdown time 1051 is equal to the OS shutdown time measured this time or longer, the value of the OS shutdown time 1051 is not updated.

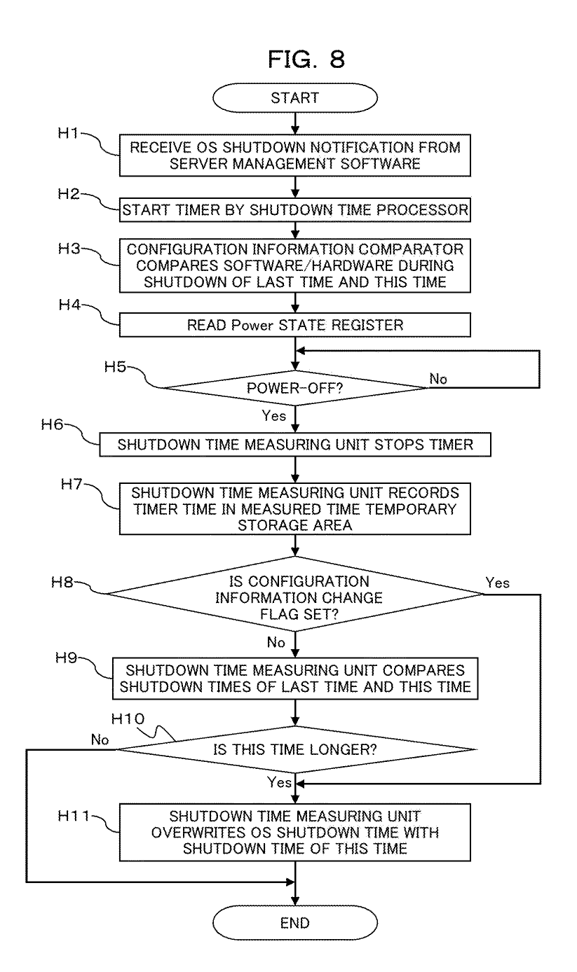

A concrete process by the shutdown time measuring unit 105 will be described below following the flow chart illustrated in FIG. 8.

The server management software monitor 107 is, for example, the processor 11 as illustrated in FIG. 3 and monitors for a state in which the server management software 30 is hung (hang-up, abnormally stopped).

As described above, the server management software 30 transmits a reset request of Watchdog Timer to the BMC 10 at predetermined intervals (for example, every five seconds) that are preset.

If, for example, no reset request of Watchdog Timer from the server management software 30 is input for a second predetermined interval (for example, every 10 seconds) longer than the interval of the reset request of Watchdog Timer input from the server management software 30, the server management software monitor 107 determines (detects) that the server management software 30 is hung.

If the hang-up of the server management software 30 is detected after an error of the PCIe bus is detected by the PCIe bus monitoring processor 104 described below, the server management software monitor 107 invokes the PCIe bus monitoring processor 104.

Thus, when a communication failure is detected by the PCIe bus monitoring processor 104, the server management software monitor 107 functions as a software monitor that detects an abnormally stopped state (hang-up) of the server management software 30.

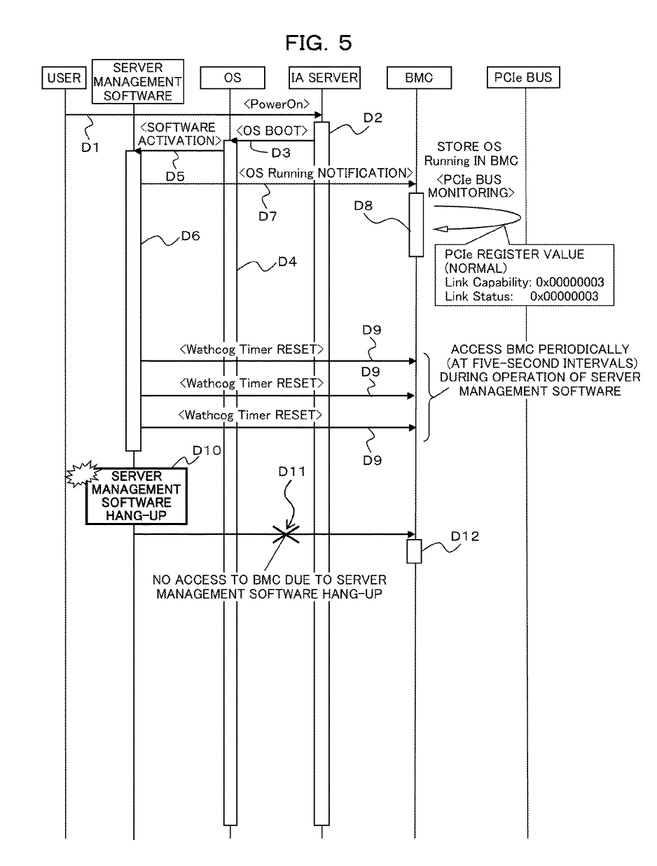

A concrete process by the server management software monitor 107 will be described below following the sequence diagram illustrated in FIG. 5.

The configuration information comparator 106 is, for example, the processor 11 as illustrated in FIG. 3 and compares the software configuration and hardware configuration when the OS is shut down last time and the software configuration and hardware configuration when the OS is shut down this time.

If, as a result of comparison, the fact that the software configuration or the hardware configuration of the IA server 1 is changed is detected, the configuration information comparator 106 sets a value (for example, “1”) indicating that a configuration change is detected to the configuration information change flag 1063. Also when the fact that the software configuration or the hardware configuration of the IA server 1 is changed is detected, the configuration information comparator 106 makes a notification to the shutdown time measuring unit 105.

The comparison of software configuration is made using the software configuration information 1061 that is transmitted from the server management software 30 (software configuration transmitter 33) and is the latest (latest generation) and the software configuration information 1061 when the OS is shut down last time (previous generation).

The configuration information comparator 106 acquires the software name and version number from each piece of the software configuration information 1061 of the latest generation and the previous generation.

For example, the configuration information comparator 106 compares the software configuration information 1061 of the latest generation and the previous generation. If a software name present in the software configuration information 1061 of the latest generation is not found in the software configuration information 1061 of the previous generation, the configuration information comparator 106 sets a value (for example, “1”) indicating that a configuration change is detected to the configuration information change flag 1063.

If software of the same name is present in the software configuration information 1061 of both the latest generation and the previous generation, the configuration information comparator 106 compares versions of the software.

If versions of the same software name are different in the software configuration information 1061, which means that the version of the software has been changed, the configuration information comparator 106 sets a value (for example, “1”) indicating that a configuration change is detected to the configuration information change flag 1063.

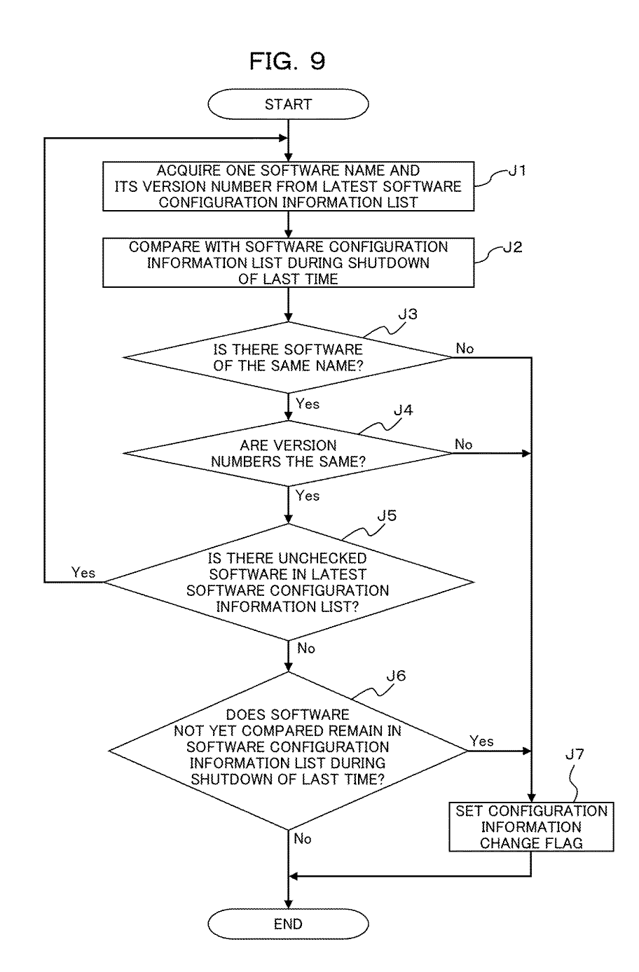

A concrete method of comparing software configurations by the configuration information comparator 106 will be described below following the flow chart illustrated in FIG. 9.

On the other hand, the comparison of hardware configuration is made using the hardware configuration information 1062 that is stored in a predetermined area of the memory 12 and is the latest (latest generation) and the hardware configuration information 1062 when the OS is shut down last time (previous generation).

If at least one of, for example, CPU Name, Part Number, Vendor ID, and Device ID is different between the hardware configuration information 1062 of the latest generation and the hardware configuration information 1062 of the previous generation, this means that the hardware configuration has been changed. If the hardware configuration is determined to have been changed, the configuration information comparator 106 sets a value (for example, “1”) indicating that a configuration change is detected to the configuration information change flag 1063.

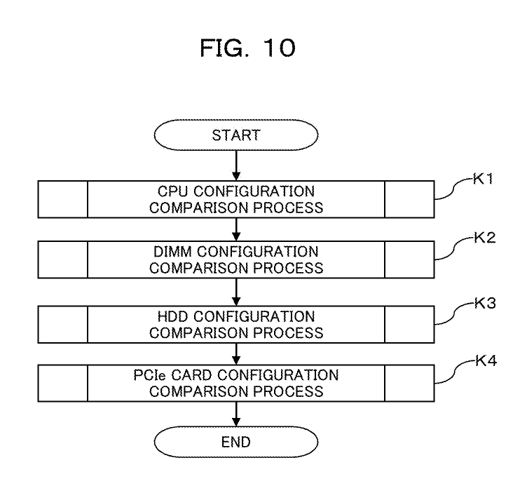

A concrete method of comparing hardware configurations by the configuration information comparator 106 will be described below following the flow charts illustrated in FIGS. 10 to 14.

The PCIe bus monitoring processor 104 is, for example, the processor 11 as illustrated in FIG. 3 and monitors for a failure of the PCIe bus. More specifically, the PCIe bus monitoring processor 104 reads values of the Link Capability register and the Link Status register of each of the PCIe ports 29 of the PCIe switch 23 and compares these values. If the value of the Capability register and that of the Link Status register mismatch, the PCIe bus monitoring processor 104 determines that a failure is detected in the PCIe bus and sets a value (for example, “1”) indicating that a failure is detected in the PCIe bus as the failure detection flag 1041. The failure detection flag 1041 is stored in a predetermined area of the memory 12.

Thus, the PCIe bus monitoring processor 104 functions as a communication failure detector that monitors the communication state of the PCIe bus 28 to detect a communication failure of the PCIe bus 28.

When a failure of the PCIe bus 28 is detected, the PCIe bus monitoring processor 104 waits until the OS shutdown time 1051 stored in the memory 12 passes and then checks the power state of the IA server 1.

Then, if the IA server 1 is in a power-off state, the PCIe bus monitoring processor 104 cancels (clears) the set value (for example, changes the value to “0”) set to the failure detection flag 1041 and indicating that a failure is detected in the PCIe bus. The detected communication failure is canceled. This is because if the IA server 1 is in a power-off state, the PCIe bus failure detected previously can be determined to be erroneous detection caused by a shutdown process of the OS.

Thus, the PCIe bus monitoring processor 104 function as a failure manager that checks the power state of the IA server 1 after waiting for the shutdown time (OS shutdown time) of the same IA server 1 since the detection of a failure of the PCIe bus 28, and if the IA server 1 is found to be in a power-off state, cancels the detected communication failure.

On the other hand, if, as a result of checking the power state of the IA server 1, the IA server 1 is in a power-on state, the PCIe bus monitoring processor 104 monitors for a failure of the PCIe bus again. That is, the PCIe bus monitoring processor 104 retries monitoring of the PCIe bus. More specifically, the PCIe bus monitoring processor 104 reads values of the Link Capability register and the Link Status register of each of the PCIe ports 29 of the PCIe switch 23 and compares these values again.

Then, if the values of the Link Capability register and the Link Status register mismatch, the PCIe bus monitoring processor 104 determines that a failure has occurred in the PCIe bus and registers an error log in SEL.

Thus, if the IA server 1 is in a power-on state, the PCIe bus monitoring processor 104 monitors the communication state of the PCIe bus 28 and, if a communication failure is detected again, determines the communication failure of the PCIe bus 28 in the IA server 1.

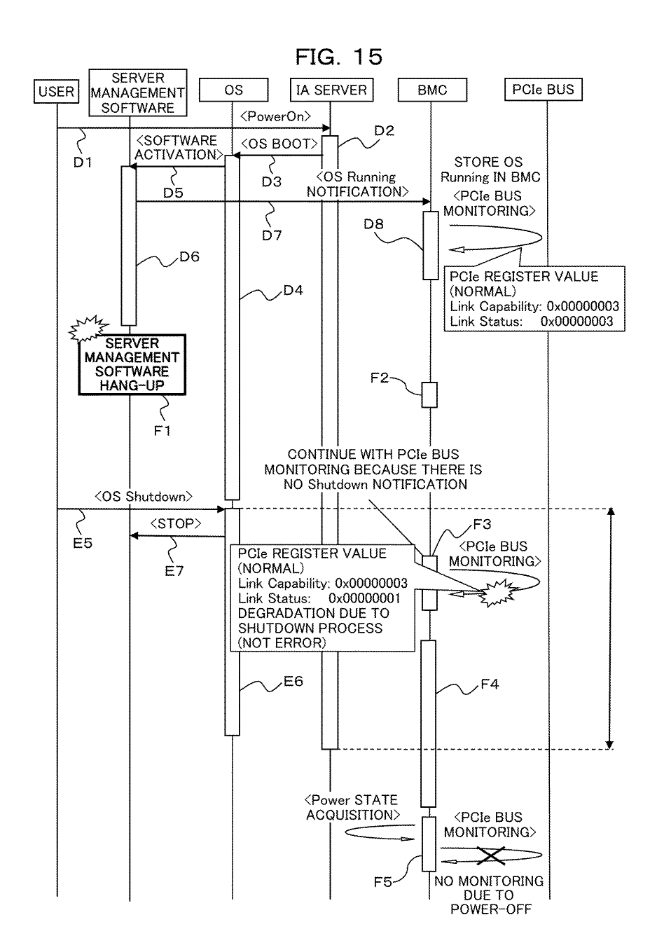

A concrete process by the PCIe bus monitoring processor 104 will be described below following the sequence diagram illustrated in FIG. 15.

(B) Operation

First, a hang-up detection process of the server management software 30 by the server management software monitor 107 of the IA server 1 as an exemplary embodiment configured as described above will be described following the sequence diagram illustrated in FIG. 5.

When the user inputs an activation instruction of the IA server 1 (see Symbol D1), the IA server 1 is activated (Power on) (see Symbol D2). The OS is booted by the IA server 1 (see Symbol D3) and the OS is booted (see Symbol D4). The OS activates the server management software 30 (Symbol D5) and the server management software 30 is thereby activated (see Symbol D6).

The OS state notification unit 31 of the server management software 30 transmits an OS Running notification to the BMC 10 (see Symbol D7). The BMC 10 having received the OS Running notification stores a value indicating “OS Running” in the OS state storage unit 101. In the case of OS Running, the PCIe bus monitoring processor 104 performs monitoring of the PCIe bus (see Symbol D8).

In the example illustrated in FIG. 5, “0x00000003” is stored in each of the Link Capability register and the Link Status register as the PCIe register value and thus, a normal state is represented.

The server management software 30 periodically (for example, every five seconds) transmits a reset request of Watchdog Timer to the BMC 10 (Symbol D9).

In the BMC 10, the server management software monitor 107 recognizes that the server management software 30 is “operating” when periodically (for example, every five seconds) accessed (reset request of Watchdog Timer) by the server management software 30.

If the server management software 30 is hung (see Symbol D10), there is no access (reset request of Watchdog Timer) to the BMC 10 from the server management software 30 (Symbol D11).

If no access (reset request of Watchdog Timer) to the BMC 10 from the server management software 30 is input for a second predetermined interval (for example, every 10 seconds), the server management software monitor 107 detects that the server management software 30 is hung (Symbol D12).

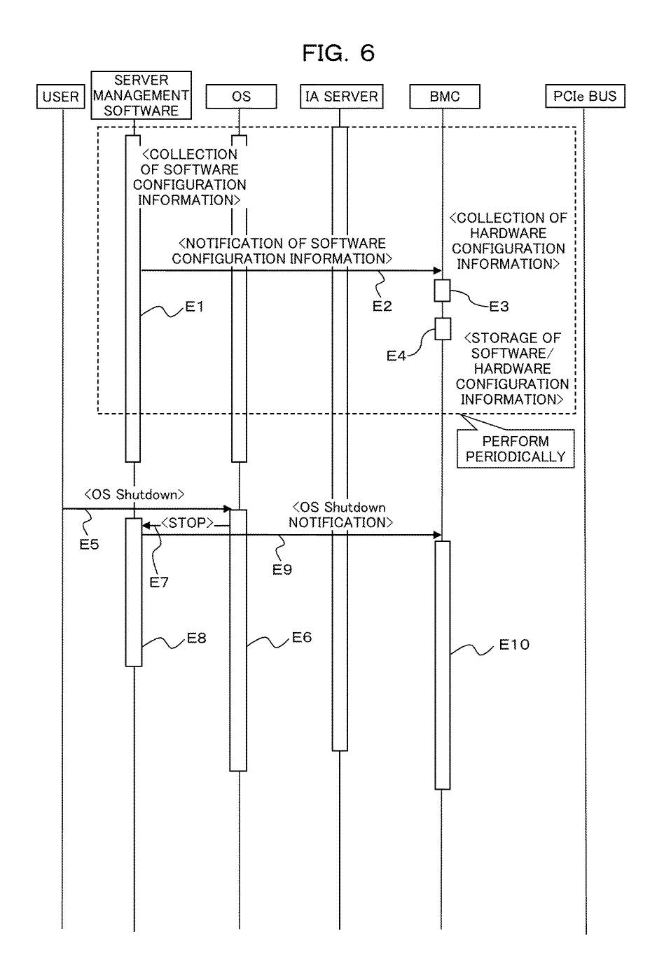

Next, a collection process of various kinds of information by the IA server 1 as an exemplary embodiment will be described following sequence diagram illustrated in FIG. 6.

The software configuration collector 32 of the server management software 30 collects software information about the software 34 (see Symbol E1) and the software configuration transmitter 33 transmits the collected software configuration information to the BMC 10 (see Symbol E2).

In the BMC 10, the hardware configuration collector 102 collects hardware configuration information about each piece of hardware provided in the IA server 1 (see Symbol E3).

The software configuration information and hardware configuration information are stored in predetermined areas of the memory 12 as the software configuration information 1061 and the hardware configuration information 1062 respectively (Symbol E4).

The software and hardware configurations may be changed even while the OS operates on the IA server 1 and thus, the collection process of the software configuration information and hardware configuration information is performed periodically. Accordingly, the software configuration information 1061 and the hardware configuration information 1062 that are the latest are held in the BMC 10.

When the user inputs a shutdown execution instruction of the OS on the IA server 1 (see Symbol E5), a shutdown process is performed by the OS (see Symbol E6). When the OS notifies the server management software 30 of a stop instruction (Symbol E7), a stop process of the server management software 30 is performed (see Symbol E8).

The OS state notification unit 31 of the server management software 30 transmits an OS Shutdown notification to the BMC 10 (see Symbol E9). In the BMC 10, the shutdown time measuring unit 105 starts to clock by a timer using the OS Shutdown notification as a trigger (Symbol E10). That is, the shutdown time measuring unit 105 measures the time from the reception of the OS Shutdown notification to power-off of the IA server 1 as the shutdown time.

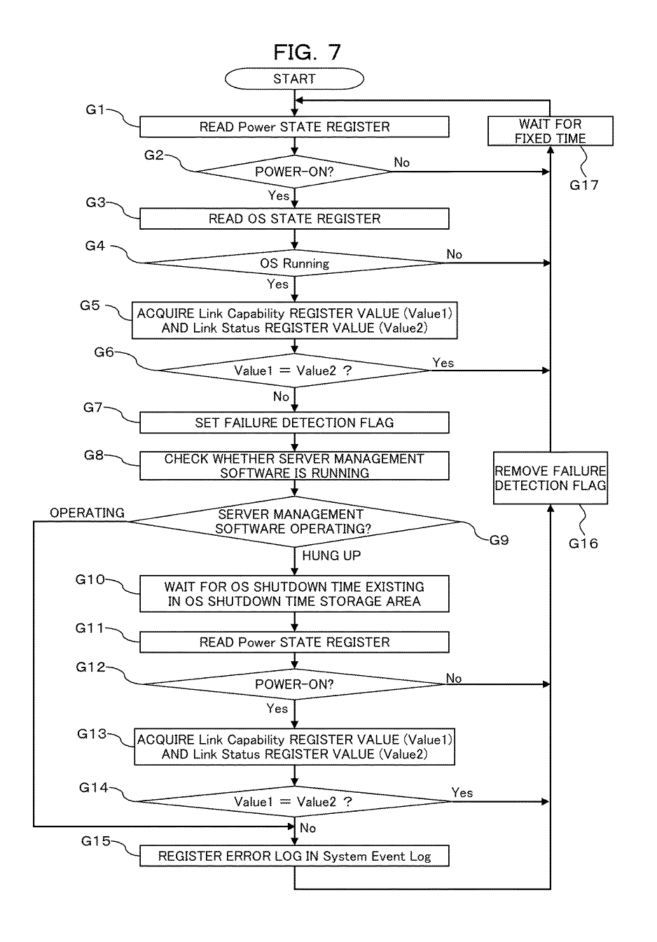

Next, a process by the PCIe bus monitoring processor 104 in the IA server 1 as an exemplary embodiment will be described following the flow chart (steps G1 to G17) illustrated in FIG. 7.

The PCIe bus monitoring processor 104 reads the value of the Power state register 25 (step G1) and checks whether the IA server 1 is in a power-on state (step G2). If the IA server 1 is not in a power-on state (see No route in step G2), the PCIe bus monitoring processor 104 waits for a fixed time (step G17) before returning to step G1.

If the IA server 1 is in a power-on state (see Yes route in step G2), the PCIe bus monitoring processor 104 proceeds to step G3.

In step G3, the PCIe bus monitoring processor 104 reads the value stored in the OS state storage unit 101 and representing the OS execution state and checks whether the OS is being executed, that is, whether the OS state is “OS Running” (step G4).

If, as a result of checking, the OS state is not “OS Running” (see No route in step G4), the PCIe bus monitoring processor 104 proceeds to step G17. On the other hand, if the OS state is “OS Running” (see Yes route in step G4), the PCIe bus monitoring processor 104 proceeds to step G5.

In step G5, the PCIe bus monitoring processor 104 reads the value of the Link Capability register and that of the Link Status register of each of the PCIe ports 29 of the PCIe switch 23. Hereinafter, for the sake of convenience, the value of the Link Capability register may be called “Value1” and the value of the Link Status register may be called “Value2”.

The PCIe bus monitoring processor 104 compares and checks whether “Value1” and “Value2” match (step G6). If, as a result of checking, “Value1” and “Value2” match (see Yes route in step G6), it is determined that no failure of the PCIe bus is detected and the PCIe bus monitoring processor 104 proceeds to step G17.

If “Value1” and “Value2” mismatch (see No route in step G6), it is determined that a failure (for example, a transmission delay) of the PCIe bus has occurred and the PCIe bus monitoring processor 104 sets a value (for example, “1”) indicating that a failure is detected in the PCIe bus as the failure detection flag 1041 (step G7).

The server management software monitor 107 checks whether the server management software 30 is operating (step G8). If, as a result of checking whether the server management software 30 is operating (step G9), the server management software 30 is operating (see “Operating” route in step G9), the PCIe bus monitoring processor 104 registers an error log in SEL (step G15).

Then, in step G16, the PCIe bus monitoring processor 104 cancels the value (for example, changes the value to “0”) set to the failure detection flag 1041 and indicating that a failure is detected in the PCIe bus before proceeding to step G17.

On the other hand, if, as a result of checking, the server management software 30 is not operating (see “Hung Up” route in step G9), the PCIe bus monitoring processor 104 waits until the OS shutdown time 1051 stored in the memory 12 passes (step G10).

Then, the PCIe bus monitoring processor 104 reads the value of the Power state register 25 (step G11) and checks whether the IA server 1 is in a power-on state (step G12). If the IA server 1 is not in a power-on state (see No route in step G12), the PCIe bus monitoring processor 104 proceeds to step G16.

If the IA server 1 is in a power-on state (see Yes route in step G12), in step G13, the PCIe bus monitoring processor 104 reads the value (“Value1”) of the Link Capability register and the value (“Value2”) of the Link Status register of each of the PCIe ports 29 of the PCIe switch 23.

The PCIe bus monitoring processor 104 compares and checks whether “Value1” and “Value2” match (step G14). If, as a result of checking, “Value1” and “Value2” match (see Yes route in step G14), it is determined that no failure of the PCIe bus is detected and the PCIe bus monitoring processor 104 proceeds to step G16.

If “Value1” and “Value2” mismatch (see No route in step G14), it is determined that a failure of the PCIe bus is detected and the PCIe bus monitoring processor 104 proceeds to step G15.

In the flow chart illustrated in FIG. 7, for example, the PCIe bus monitoring processor 104 may read the value stored in the OS state storage unit 101 and indicating the execution state of the OS while transitioning from the process in step G12 to the process in step G13 to check whether the OS is being executed, that is, whether the OS state is “OS Running”. In this case, if, as a result of checking, the OS state is not “OS Running”, the PCIe bus monitoring processor 104 desirably proceeds to step G16 and if the OS state is “OS Running”, the PCIe bus monitoring processor 104 desirably proceeds to step G13. Accordingly, when the OS is not being executed, the processes in steps G13 to G15 can be omitted.

Next, a measurement process of the OS shutdown time by the shutdown time measuring unit 105 in the IA server 1 as an exemplary embodiment will be described following the flow chart (steps H1 to H11) illustrated in FIG. 8.

When an OS Shutdown notification is received from the server management software 30 (step H1), the shutdown time measuring unit 105 activates the timer to start clocking the time (step H2).

The configuration information comparator 106 compares the software configuration and hardware configuration when the OS is shut down last time and the software configuration and hardware configuration when the OS is shut down this time (step H3).

The PCIe bus monitoring processor 104 reads the value of the Power state register 25 (step H4) and checks whether the IA server 1 is in a power-off state (step H5).

If the IA server 1 is in a power-on state (see No route in step H5), the PCIe bus monitoring processor 104 repeats step H5.

When the IA server 1 changes to a power-off state (see Yes route in step H5), the shutdown time measuring unit 105 stops the time to stop clocking the OS shutdown time (step H6).

The shutdown time measuring unit 105 stores the time measured by the timer in the measured time temporary storage area of the memory 12 (step H7).

The shutdown time measuring unit 105 checks whether a value (for example, “1”) indicating that a configuration change is detected is set to the configuration information change flag 1063, that is, the configuration of the IA server 1 has been changed (step H8).

When a value indicating that a configuration change is detected is set to the configuration information change flag 1063 (see Yes route in step H8), the shutdown time measuring unit 105 updates the value of the OS shutdown time 1051 by overwriting using the measured time (OS shutdown time) stored in the measured time temporary storage area (step H11) before terminating the process.

On the other hand, when no value indicating that a configuration change is detected is set to the configuration information change flag 1063 (see No route in step H8), the shutdown time measuring unit 105 compares the OS shutdown time 1051, that is, the OS shutdown time measured previously and the OS shutdown time stored in the measured time temporary storage area and measured this time (step H9).

That is, the shutdown time measuring unit 105 compares whether the OS shutdown time measured this time is longer than the OS shutdown time 1051 measured previously (step H10). If the OS shutdown time 1051 measured this time is longer than the OS shutdown time measured previously (see Yes route in step H10), the shutdown time measuring unit 105 proceeds to step H11. That is, the shutdown time measuring unit 105 updates the value of the OS shutdown time 1051 by overwriting using the measured time stored in the measured time temporary storage area.

On the other hand, if the OS shutdown time 1051 measured previously is longer than the OS shutdown time measured this time or the OS shutdown time 1051 measured previously is equal to the OS shutdown time measured this time (see No route in step H10), the shutdown time measuring unit 105 terminates the process without updating the OS shutdown time 1051.

Next, a comparison process of software configurations by the configuration information comparator 106 of the IA server 1 as an exemplary embodiment will be described following the flow chart illustrated in FIG. 9 (steps J1 to J7).

The configuration information comparator 106 acquires one software name and its version number from the software configuration information 1061 of the latest generation as comparison information (step J1).

The configuration information comparator 106 compares the software name and its version number acquired in step J1 with one or more software names and their version numbers (list) recorded in the software configuration information 1061 of the previous generation (step J2).

The configuration information comparator 106 checks whether there is software in the software configuration information 1061 of the latest generation having the same software name as that of the comparison information (step J3).

If there is no software in the software configuration information 1061 of the latest generation having the same software name as that of the comparison information (see No route in step J3), the software of the comparison information can be considered to be software installed newly. Thus, the configuration information comparator 106 sets a value (for example, “1”) indicating that a configuration change is detected to the configuration information change flag 1063 (step J7) before terminating the process.

If there is software in the software configuration information 1061 of the latest generation having the same software name as that of the comparison information (see Yes route in step J3), next the configuration information comparator 106 checks whether versions of the software are the same (step J4).

If the software versions are different (see No route in step J4), the version of the software is considered to have been upgraded or downgraded. Thus, the configuration information comparator 106 proceeds to step J7 and sets a value (for example, “1”) indicating that a configuration change is detected to the configuration information change flag 1063.

On the other hand, if the software versions are the same (see Yes route in step J4), next the configuration information comparator 106 checks whether there remains software in the software configuration information 1061 of the latest generation that has not yet been compared with the software configuration information 1061 of the previous generation (step J5).

If there remains software in the software configuration information 1061 of the latest generation that is not yet checked (see Yes route in step J5), the configuration information comparator 106 returns to step J1 to acquire one software name that is not yet checked and its version number in the software configuration information 1061 of the latest generation as comparison information.

If there remains no software in the software configuration information 1061 of the latest generation that is not yet checked (see No route in step J5), the configuration information comparator 106 checks whether there remains software in the software configuration information 1061 of the previous generation that has not yet been compared (step J6).

If there remains software in the software configuration information 1061 of the previous generation that has not yet been compared (see Yes route in step J6), the relevant software is considered to have been uninstalled. Thus, the configuration information comparator 106 proceeds to step J7 and sets a value (for example, “1”) indicating that a configuration change is detected to the configuration information change flag 1063.

If there remains no software in the software configuration information 1061 of the previous generation that has not yet been compared (see No route in step J6), the configuration information comparator 106 terminates the process.

Next, an overview of a comparison process of hardware configurations by the configuration information comparator 106 of the IA server 1 as an exemplary embodiment will be provided following the flow chart illustrated in FIG. 10 (steps K1 to K4).

In the example illustrated in FIG. 10, the configuration information comparator 106 compares the hardware configuration information 1062 of the latest generation and the hardware configuration information 1062 of the previous generation in the order of the configuration (step K1) of the CPU 21, the configuration (step K2) of the DIMM 22, the configuration (step K3) of the HDD, and the configuration (step K4) of the PCIe card 24.

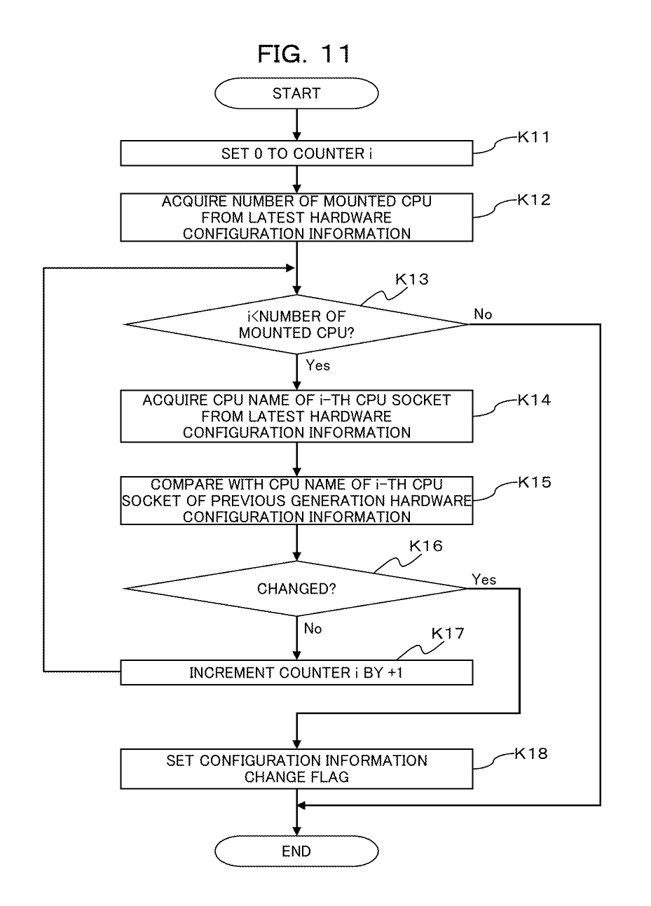

Detailed processes of these configuration comparisons will be described below using the flow charts illustrated in FIGS. 11 to 14.

Incidentally, the order of comparing a plurality of types of hardware configurations by the configuration information comparator 106 is not limited to the order illustrated in FIG. 10. That is, the order of comparison may appropriately be interchanged and also a configuration comparison of other hardware may be added or a configuration comparison of a portion of hardware may be omitted.

First, a configuration comparison process of the CPU 21 by the configuration information comparator 106 of the IA server 1 as an exemplary embodiment will be described following the flow chart (steps K11 to K18) illustrated in FIG. 11.

The configuration information comparator 106 first initializes the counter value by setting 0 to a counter i (i=0) (step K11).

Then, the configuration information comparator 106 acquires the number (Count) of the CPUs 21 that are mounted from the hardware configuration information 1062 of the latest generation (step K12).

The configuration information comparator 106 checks whether i<number of mounted CPUs holds (step K13). If i is equal to or larger than the number of mounted CPUs (see No route in step K13), the configuration information comparator 106 terminates the process.

If i<number of mounted CPUs holds (see Yes route in step K13), the configuration information comparator 106 acquires the CPU name of the i-th CPU socket from the hardware configuration information 1062 of the latest generation (step K14).

The configuration information comparator 106 compares the CPU name of the i-th CPU socket acquired in step K14 with the CPU name of the i-th CPU socket in the hardware configuration information 1062 of the previous generation (step K15). That is, the configuration information comparator 106 checks whether the CPU of the i-th CPU socket is changed (step K16).

If the CPU name of the i-th CPU socket in the hardware configuration information 1062 of the latest generation does not match the CPU name of the i-th CPU socket in the hardware configuration information 1062 of the previous generation, this means that the CPU 21 that is different from the CPU 21 when the hardware configuration information 1062 is acquired previously is mounted.

If the CPU of the i-th CPU socket is changed (see Yes route in step K16), the configuration information comparator 106 proceeds to step K18.

In step K18, the configuration information comparator 106 sets a value (for example, “1”) indicating that a configuration change is detected to the configuration information change flag 1063 before terminating the process.

On the other hand, if the CPU of the i-th CPU socket is not changed (see No route in step K16), the configuration information comparator 106 increments the counter i (i=i+1) (step K17) before returning to step K13.

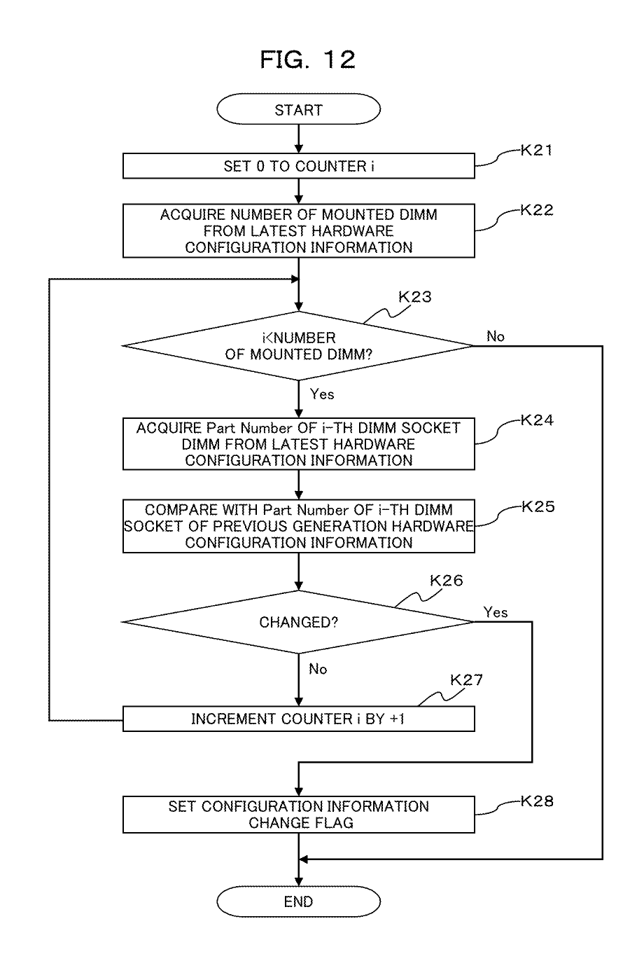

Next, a configuration comparison process of the DIMM 22 by the configuration information comparator 106 of the IA server 1 as an exemplary embodiment will be described following the flow chart (steps K21 to K28) illustrated in FIG. 12.

The configuration information comparator 106 first initializes the counter value by setting 0 to the counter i (i=0) (step K21).

Then, the configuration information comparator 106 acquires the number (Count) of the DIMMs 22 that are mounted from the hardware configuration information 1062 of the latest generation (step K22).

The configuration information comparator 106 checks whether i<number of mounted DIMMs holds (step K23). If i is equal to or larger than the number of mounted DIMMs (see No route in step K23), the configuration information comparator 106 terminates the process.

If i<number of mounted DIMMs holds (see Yes route in step K23), the configuration information comparator 106 acquires Part Number of the DIMM 22 of the i-th DIMM socket from the hardware configuration information 1062 of the latest generation (step K24).

The configuration information comparator 106 compares Part Number of the i-th DIMM socket acquired in step K24 with Part Number of the i-th DIMM socket in the hardware configuration information 1062 of the previous generation (step K25). That is, the configuration information comparator 106 checks whether the DIMM 22 of the i-th DIMM socket is changed (step K26).

If Part Number of the i-th DIMM socket in the hardware configuration information 1062 of the latest generation does not match Part Number of the i-th DIMM socket in the hardware configuration information 1062 of the previous generation, this means that the DIMM 22 that is different from the DIMM 22 when the hardware configuration information 1062 is acquired previously is mounted.

If the DIMM 22 of the i-th DIMM socket is changed (see Yes route in step K26), the configuration information comparator 106 proceeds to step K28.

In step K28, the configuration information comparator 106 sets a value (for example, “1”) indicating that a configuration change is detected to the configuration information change flag 1063 before terminating the process.

On the other hand, if the DIMM of the i-th DIMM socket is not changed (see No route in step K26), the configuration information comparator 106 increments the counter i (i=i+1) (step K27) before returning to step K23.

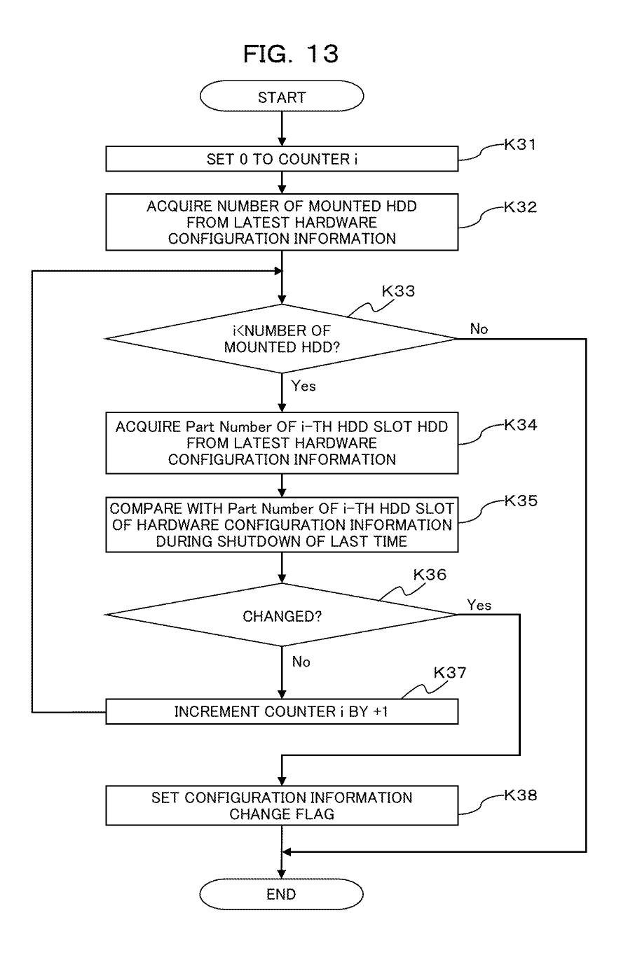

Next, a configuration comparison process of HDD by the configuration information comparator 106 of the IA server 1 as an exemplary embodiment will be described following the flow chart (steps K31 to K38) illustrated in FIG. 13.

The configuration information comparator 106 first initializes the counter value by setting 0 to the counter i (i=0) (step K31).

Then, the configuration information comparator 106 acquires the number (Count) of HDDs that are mounted from the hardware configuration information 1062 of the latest generation (step K32).

The configuration information comparator 106 checks whether i<number of mounted HDDs holds (step K33). If i is equal to or larger than the number of mounted HDDs (see No route in step K33), the configuration information comparator 106 terminates the process.

If i<number of mounted HDDs holds (see Yes route in step K33), the configuration information comparator 106 acquires Part Number of the HDD of the i-th HDD slot from the hardware configuration information 1062 of the latest generation (step K34).

The configuration information comparator 106 compares Part Number of the i-th HDD slot acquired in step K34 with Part Number of the i-th HDD slot in the hardware configuration information 1062 of the previous generation (step K35). That is, the configuration information comparator 106 checks whether the HDD of the i-th HDD slot is changed (step K36).

If Part Number of the i-th HD slot in the hardware configuration information 1062 of the latest generation does not match Part Number of the i-th HDD slot in the hardware configuration information 1062 of the previous generation, this means that HDD that is different from the HDD when the hardware configuration information 1062 is acquired previously is mounted.

If the HDD of the i-th HDD slot is changed (see Yes route in step K36), the configuration information comparator 106 proceeds to step K38.

In step K38, the configuration information comparator 106 sets a value (for example, “1”) indicating that a configuration change is detected to the configuration information change flag 1063 before terminating the process.

On the other hand, if the HDD of the i-th HDD slot is not changed (see No route in step K36), the configuration information comparator 106 increments the counter i (i=i+1) (step K37) before returning to step K33.

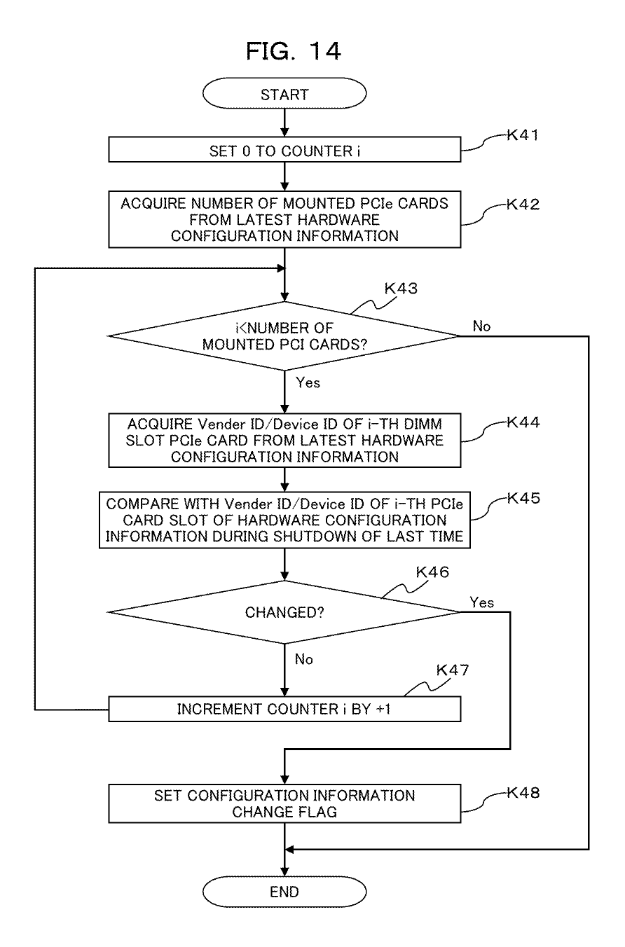

Next, a configuration comparison process of the PCIe card 24 by the configuration information comparator 106 of the IA server 1 as an exemplary embodiment will be described following the flow chart (steps K41 to K48) illustrated in FIG. 14.

The configuration information comparator 106 first initializes the counter value by setting 0 to the counter i (i=0) (step K41).

Then, the configuration information comparator 106 acquires the number (Count) of the PCIe cards 24 that are mounted from the hardware configuration information 1062 of the latest generation (step K42).

The configuration information comparator 106 checks whether i<number of mounted PCIe cards holds (step K43). If i is equal to or larger than the number of mounted PCIe cards (see No route in step K43), the configuration information comparator 106 terminates the process.

If i<number of mounted PCIe cards holds (see Yes route in step K43), the configuration information comparator 106 acquires Vendor ID and Device ID of the PCIe card 24 of the i-th PCIe card slot from the hardware configuration information 1062 of the latest generation (step K44).

The configuration information comparator 106 compares Vendor ID and Device ID of the PCIe card 24 of the i-th PCIe card slot acquired in step K44 with Vendor ID and Device ID of the PCIe card 24 of the i-th PCIe card slot in the hardware configuration information 1062 of the previous generation (step K45). That is, the configuration information comparator 106 checks whether the PCIe card 24 of the i-th PCIe card slot is changed (step K46).

If Vendor ID and Device ID of the PCIe card 24 of the i-th PCIe card slot in the hardware configuration information 1062 of the previous generation and Vendor ID and Device ID of the PCIe card 24 of the i-th PCIe card slot in the hardware configuration information 1062 of the previous generation do not match, this means that the PCIe card 24 that is different from the PCIe card 24 when the hardware configuration information 1062 is acquired previously is mounted.

If the PCIe card 24 of the i-th PCIe card slot is changed (see Yes route in step K46), the configuration information comparator 106 proceeds to step K48.

In step K48, the configuration information comparator 106 sets a value (for example, “1”) indicating that a configuration change is detected to the configuration information change flag 1063 before terminating the process.

On the other hand, if the PCIe card 24 of the i-th PCIe card slot is not changed (see No route in step K46), the configuration information comparator 106 increments the counter i (i=i+1) (step K47) before returning to step K43.

Next, a process when speed degradation is detected in the PCIe bus while the OS is shut down in the IA server 1 as an exemplary embodiment configured as described above will be described following the sequence diagram illustrated in FIG. 15.

In FIG. 15, the same symbols as those described above indicate similar processes and a description thereof is omitted. Also in FIG. 15, the illustration of a portion of processes illustrated in FIGS. 5 and 6 is omitted.

When the user inputs an activation instruction of the IA server 1 (see Symbol D1), the IA server 1 is activated (Power on) (see Symbol D2). The OS is booted by the IA server 1 (see Symbol D3) and the OS is booted (see Symbol D4). The OS activates the server management software 30 (Symbol D5) and the server management software 30 is thereby activated (see Symbol D6).

The OS state notification unit 31 of the server management software 30 transmits an OS Running notification to the BMC 10 (see Symbol D7). The BMC 10 having received the OS Running notification stores a value indicating “OS Running” in the OS state storage unit 101. In the case of OS Running, the PCIe bus monitoring processor 104 performs monitoring of the PCIe bus (see Symbol D8).

In the example illustrated in FIG. 15, “0x00000003” is stored in each of the Link Capability register and the Link Status register as the PCIe register value and thus, a normal state is represented.

Here, if hang-up of the server management software 30 occurs (Symbol F1), the server management software monitor 107 detects the hang-up of the server management software 30 in the BMC 10 (Symbol F2).

When the user inputs a shutdown execution instruction of the OS on the IA server 1 (see Symbol E5), a shutdown process is performed by the OS (see Symbol E6). When the OS notifies the server management software 30 of a stop instruction (Symbol E7).

Here, no OS Shutdown notification is received by the BMC 10 from the OS state notification unit 31 of the server management software 30 and thus, the PCIe bus monitoring processor 104 continues to monitor the PCIe bus (see Symbol F3).

In the example illustrated in FIG. 15, while the PCIe register value “0x00000003” is stored in the Link Capability register, the PCIe register value “0x00000001” is stored in the Link Status register due to the degradation of transfer speed of the PCIe bus caused by the shutdown process. Accordingly, the PCIe bus monitoring processor 104 determines that a failure is detected in the PCIe bus and sets a value (for example, “1”) indicating that a failure is detected in the PCIe bus to a predetermined area of the memory 12 as the failure detection flag 1041.

Then, the PCIe bus monitoring processor 104 waits until the OS shutdown time 1051 stored in the memory 12 passes (Symbol F4).

After the OS shutdown time 1051 passes, the PCIe bus monitoring processor 104 acquires the value of the Power state register 25 and checks whether the IA server 1 is in a power-on state (Symbol F5). Here, the IA server 1 is in a power-off state after the shutdown process being performed. In this case, the PCIe bus monitoring processor 104 cancels the value (for example, changes the value to “0”) set to the failure detection flag 1041 and indicating that a failure is detected in the PCIe bus before terminating the process.

(C) Effect

Thus, according to the IA server 1 as an exemplary embodiment, when a failure of a degraded speed is detected in the PCIe bus, the PCIe bus monitoring processor 104 waits for an OS shutdown time and then checks whether the IA server 1 is in a power-on state if the server management software 30 is hung.

Then, if the IA server 1 is in a power-off state, the PCIe bus monitoring processor 104 cancels the value (for example, changes the value to “0”) set to the failure detection flag 1041 due to failure detection and indicating that a failure is detected in the PCIe bus.

Accordingly, a degraded speed of the PCIe bus caused by an OS shutdown process of the IA server 1 can be prevented from being erroneously detected as an error of the PCIe bus and unnecessary work or the like cab be prevented from arising.

The OS shutdown time 1051 for which the PCIe bus monitoring processor 104 waits can be kept at an appropriate value by the time needed for OS shutdown being measured and the value of the OS shutdown time 1051 being updated by the shutdown time measuring unit 105.

If, for example, the measured OS shutdown time is longer than the OS shutdown time 1051 measured previously, the shutdown time measuring unit 105 updates the value of the OS shutdown time 1051 by overwriting using the value of the OS shutdown time measured newly. Accordingly, the OS shutdown time 1051 for which the PCIe bus monitoring processor 104 waits can be kept at an appropriate value.

If the configuration information comparator 106 determines that the hardware configuration or software configuration is changed, the shutdown time measuring unit 105 updates the value of the OS shutdown time 1051 by overwriting using the value of the OS shutdown time measured newly. Accordingly, a value of the OS shutdown time 1051 in accordance with the latest configuration of the IA server 1 after the change can be set.

(D) Others

The present invention is not limited to the embodiment described above and can be carried out in various modifications without deviating from the spirit of the present invention.

In the embodiment described above, for example, the IA server 1 is described as an example of the computer 1, but the computer 1 is not limited to the above example. For example, the computer 1 may be a UNIX (registered trademark) server or the like and can be carried out in various modifications.

In addition, the numbers of the CPUs 21, the DIMMs 22, and the PCIe cards 24 provided on the IA server 1 are not limited to those illustrated in FIG. 1 and various modifications thereof can be made.

Further, the software 34 executed on the IA server 1 is not limited to Redhat (registered trademark)-release-server, Network Manager, opensssh-clients, gzip, firwalld, or pkgconfig described above and other software may also be used so that various modifications thereof can be made.

Also, the present invention can be carried out or manufactured by people skilled in the art based on the above disclosure.

According to an embodiment, erroneous detection of a communication failure accompanying an OS shutdown can be prevented.

All examples and conditional language recited herein are intended for the pedagogical purposes of aiding the reader in understanding the invention and the concepts contributed by the inventor to further the art, and are not to be construed limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A management apparatus configured to manage a computer comprising:
a communication failure detector configured to detect a communication failure concerning a data communication path by monitoring a communication state of the data communication path included in the computer;
a software monitor configured to detect an abnormally stopped state of management software executed by the computer and which outputs state information of the computer when the communication failure is detected by the communication failure detector; and
a failure manager configured to confirm a power state of the computer, after waiting for a time period taken to shut down the computer from the detection of the communication failure by the communication failure detector in a case where the abnormally stopped state of the management software is detected, and cancel, when the computer is confirmed to be in a power-off state, the communication failure detected by the communication failure detector.

2. The management apparatus according to claim 1, wherein
when the computer is in a power-on state as a result of checking the power state by the failure manager,
the communication failure detector monitors the communication state of the data communication path and, when the communication failure is detected again, determines the communication failure of the data communication path in the computer.

3. The management apparatus according to claim 1, further comprising:
a shutdown time measuring unit configured to measure the shutdown time when the computer is shut down.

4. The management apparatus according to claim 3, wherein
the shutdown time measuring unit updates the shutdown time when a configuration of the computer is changed.

5. The management apparatus according to claim 3, wherein
when the shutdown time measured newly is longer than the shutdown time measured previously, the shutdown time measuring unit updates the shutdown time using the shutdown time measured newly.

6. A computer including a processor executing software,
a data communication path, and
a management apparatus, wherein
the management apparatus comprising:
a communication failure detector configured to detect a communication failure concerning a data communication path by monitoring a communication state of the data communication path;
a software monitor configured to detect an abnormally stopped state of management software executed by the processor and which outputs state information of the computer when the communication failure is detected by the communication failure detector; and
a failure manager configured to confirm a power state of the computer, after waiting for a time period taken to shut down the communication failure detector in a case where the abnormally stopped state of the management software is detected, and cancel, when the computer is confirmed to be in a power-off state, the communication failure detected by the communication failure detector.

7. The computer according to claim 6, wherein
when the computer is in a power-on state as a result of checking the power state by the failure manager,
the communication failure detector monitors the communication state of the data communication path and, when the communication failure is detected again, determines the communication failure of the data communication path in the computer.

8. The computer according to claim 6, further comprising:
a shutdown time measuring unit configured to measure the shutdown time when the computer is shut down.

9. The computer according to claim 8, wherein
the shutdown time measuring unit updates the shutdown time when a configuration of the computer is changed.

10. The computer according to claim 8, wherein
when the shutdown time measured newly is longer than the shutdown time measured previously, the shutdown time measuring unit updates the shutdown time using the shutdown time measured newly.

11. A non-transitory computer-readable recording medium having recorded therein a management program for causing a processor to execute processes including:
detecting a communication failure concerning a data communication path by monitoring a communication state of the data communication path included in a management target apparatus;
detecting an abnormally stopped state of management software executed by the management target apparatus and which outputs state information of the management target apparatus when the communication failure is detected; and
confirming a power state of the computer, after waiting for a time period taken to shut down the management target apparatus from the detection of the communication failure in a case where the abnormally stopped state of the management software is detected, and cancelling the communication failure detected, when the management target apparatus is confirmed to be in a power-off state.

12. The non-transitory computer-readable recording medium having recorded therein a management program according to claim 11, the management program causing the processor to execute processes including:
when the management target apparatus is in a power-on state as a result of checking the power state,
monitoring the communication state of the data communication path and, when the communication failure is detected again, determining the communication failure of the data communication path in the management target apparatus.

13. The non-transitory computer-readable recording medium having recorded therein a management program according to claim 11, the management program causing the processor to execute processes including:
measuring the shutdown time when the management target apparatus is shut down.

14. The non-transitory computer-readable recording medium having recorded therein a management program according to claim 13, the management program causing the processor to execute processes including:
updating the shutdown time when a configuration of the management target apparatus is changed.

15. The non-transitory computer-readable recording medium having recorded therein a management program according to claim 13, the management program causing the processor to execute processes including:
when the shutdown time measured newly is longer than the shutdown time measured previously, updating the shutdown time using the shutdown time measured newly.
